(19) United States
(12) Patent Application Publication
(10) Pub. No.: US 2025/0331466 A1
(43) Pub. Date: Oct. 30, 2025

(54) BALE WRAP ASSEMBLY MANAGEMENT SYSTEM FOR AN AGRICULTURAL HARVESTER

(71) Applicant: CNH Industrial America LLC, New Holland, PA (US)

(72) Inventors: Francisco Rivera, Leola, PA (US); Daniel Dallman, Eldridge, IA (US); Scott Simmons, Lititz, PA (US); Shane Peot, Appleton, WI (US); Niels Dybro, Muscatine, IA (US)

(21) Appl. No.: 19/194,885

(22) Filed: Apr. 30, 2025

Related U.S. Application Data
(60) Provisional application No. 63/640,285, filed on Apr. 30, 2024.

(51) Int. Cl. A01F 15/07; B65B 11/04; B65B 41/16

(52) U.S. Cl. CPC A01F 15/0715; B65B 11/04; B65B 41/16

(57) ABSTRACT

A bale wrap assembly management system for an agricultural harvester includes a bale wrap assembly storage compartment having a storage compartment frame and a carriage movably coupled to the storage compartment frame. The carriage is configured to store multiple bale wrap assemblies, and the carriage is configured to move with respect to a vertical axis of the agricultural harvester between a storage position and a delivery position. The bale wrap assembly management system also includes a bale wrap feeding assembly having a feeding assembly frame configured to move with respect to a lateral axis of the agricultural harvester from a feeding position to a loading position. The bale wrap feeding assembly also includes a bale wrap assembly support coupled to the feeding assembly frame and configured to support an active bale wrap assembly of the plurality of bale wrap assemblies.

### CROSS-REFERENCE TO RELATED APPLICATION

This application claims priority from and the benefit of U.S. Provisional Application Ser. No. 63/640,285, entitled “BALE WRAP ASSEMBLY MANAGEMENT SYSTEM FOR AN AGRICULTURAL HARVESTER”, filed Apr. 30, 2024, which is hereby incorporated by reference in its entirety.

### BACKGROUND

The present disclosure relates generally to a bale wrap assembly management system for an agricultural harvester.

Agricultural harvesters are used to harvest agricultural products (e.g., cotton or other natural material(s)). For example, an agricultural harvester may include a header having drums configured to harvest the agricultural product from a field. The agricultural harvester may also include an air-assisted conveying system configured to move the agricultural product from the drums to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale wrap assembly management system for an agricultural harvester includes a bale wrap assembly storage compartment having a storage compartment frame and a carriage movably coupled to the storage compartment frame. The carriage is configured to store multiple bale wrap assemblies, and the carriage is configured to move with respect to a vertical axis of the agricultural harvester between a storage position and a delivery position. The bale wrap assembly management system also includes a bale wrap feeding assembly having a feeding assembly frame configured to move with respect to a lateral axis of the agricultural harvester from a feeding position to a loading position. The bale wrap feeding assembly also includes a bale wrap assembly support coupled to the feeding assembly frame and configured to support an active bale wrap assembly of the plurality of bale wrap assemblies. The bale wrap assembly support is configured to receive the active bale wrap assembly from the carriage while the carriage is in the delivery position and the feeding assembly frame is in the feeding position, and the feeding assembly frame is configured to extract the active bale wrap assembly from the carriage via movement of the feeding assembly frame from the feeding position to the loading position while the carriage is in the delivery position.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural machine system having an agricultural product transport assembly and a baler;

FIG. 2 is a schematic view of an embodiment of an agricultural product transport assembly and an embodiment of a baler that may be employed within the agricultural machine system of FIG. 1;

FIG. 3 is a perspective view of an embodiment of a bale wrap assembly management system that may be employed within the agricultural machine system of FIG. 1, in which a carriage of the bale wrap assembly management system is in a storage position, and a feeding assembly frame of the bale wrap assembly management system is in a feeding position;

FIG. 4 is a perspective view of a portion of the bale wrap assembly management system of FIG. 3, in which the carriage is in a delivery position, and the feeding assembly frame is in the feeding position;

FIG. 5 is a perspective view of the bale wrap assembly management system of FIG. 3, in which the carriage is in the delivery position, and the feeding assembly frame is in a loading position;

FIG. 6 is a side view of a portion of a bale wrap assembly storage compartment of the bale wrap assembly management system of FIG. 3, in which the carriage is in the storage position and contains five bale wrap assemblies;

FIG. 7 is a side view of a portion of the bale wrap assembly storage compartment of FIG. 6, in which the carriage is in the delivery position and contains four bale wrap assemblies;

FIG. 8 is a side view of a portion of the bale wrap assembly storage compartment of FIG. 6, in which the carriage is in the storage position and contains four bale wrap assemblies; and

FIG. 9 is a side view of a portion of the bale wrap assembly storage compartment of FIG. 6, in which the carriage is in the delivery position and contains one bale wrap assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

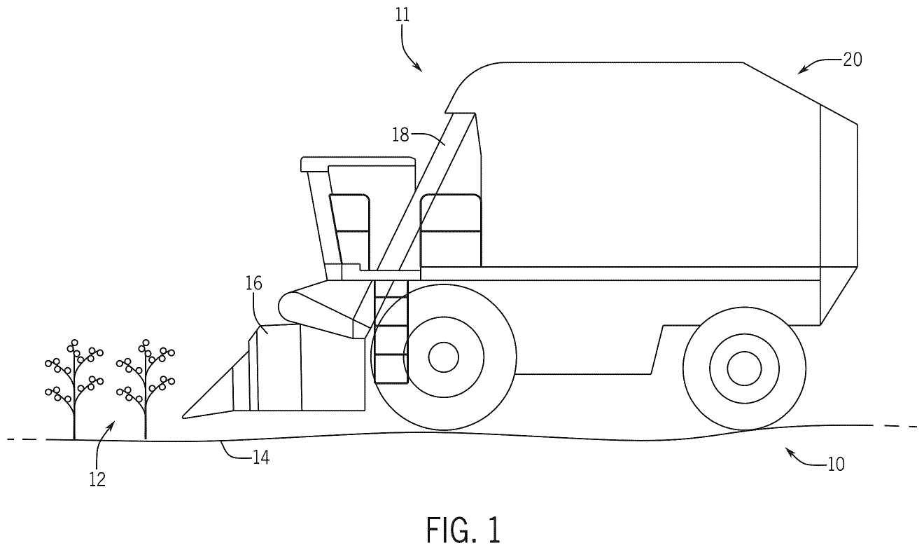

FIG. 1 is a side view of an embodiment of an agricultural machine system 10 (e.g., harvester, agricultural harvester) having an agricultural product transport assembly 11 and a baler. The agricultural machine system 10 is configured to harvest agricultural product 12 (e.g., cotton) from a field 14 and to form the agricultural product 12 into bales (e.g., agricultural bales). In the illustrated embodiment, the agricultural machine system 10 includes a header 16 having drums configured to harvest the agricultural product 12 from the field 14. Additionally, the agricultural product transport assembly 11 of the agricultural machine system 10 includes an air-assisted conveying system 18 configured to move the agricultural product 12 from the drums of the header 16 to an accumulator assembly of the agricultural product transport assembly 11. The agricultural product transport assembly 11 also includes a conveying system configured to convey the agricultural product 12 from the accumulator assembly into the baler 20 (e.g., agricultural baler). The baler 20 is supported by and/or mounted within or on a chassis of the agricultural machine system 10. The baler 20 may form the agricultural product 12 into round bales. However, in other embodiments, the baler 20 of the agricultural machine system 10 may form the agricultural product into square bales, polygonal bales, or bales of other suitable shape(s). After forming the agricultural product 12 into a bale, a bale wrapping system of the agricultural machine system 10 wraps the bale with a bale wrap to secure the agricultural product 12 within the bale and to generally maintain a shape of the bale.

As discussed in detail below, the agricultural machine system 10 includes a bale wrap assembly management system configured to manage multiple bale wrap assemblies. In certain embodiments, the bale wrap assembly management system includes a bale wrap assembly storage compartment having a storage compartment frame and a carriage movably coupled to the storage compartment frame. The carriage is configured to store multiple bale wrap assemblies, and the carriage is configured to move with respect to a vertical axis of the agricultural machine system between a storage position and a delivery position. Furthermore, the bale wrap assembly management system includes a bale wrap feeding assembly having a feeding assembly frame and a bale wrap assembly support. The feeding assembly frame is configured to move with respect to a lateral axis of the agricultural machine system from a feeding position to a loading position. In addition, the bale wrap assembly support is coupled to the feeding assembly frame and configured to support an active bale wrap assembly. Furthermore, the bale wrap assembly support is configured to receive the active bale wrap assembly from the carriage while the carriage is in the delivery position and the feeding assembly frame is in the feeding position. The feeding assembly frame is configured to extract the active bale wrap assembly from the carriage via movement of the feeding assembly frame from the feeding position to the loading position while the carriage is in the delivery position.

To transfer a bale wrap assembly from the carriage of the bale wrap assembly storage compartment to the bale wrap feeding assembly, the carriage is moved with respect to the vertical axis from the storage position to the delivery position. With the feeding assembly frame in the feeding position and the carriage in the delivery position, the bale wrap assembly is received onto the bale wrap assembly support of the bale wrap feeding assembly. As a result, the bale wrap assembly becomes the active bale wrap assembly. The feeding assembly frame is then moved with respect to the lateral axis from the feeding position to the loading position to extract the active bale wrap assembly from the carriage. The bale wrap assembly management system disclosed herein enables a large number of bale wrap assemblies (e.g., 3, 4, 5, 6, 7, 8, or more) to be stored in a small area of the agricultural machine system, thereby reducing the size of the agricultural machine system (e.g., as compared to an agricultural machine system that stores bale wrap assemblies on individual mounts). Furthermore, the bale wrap assembly management system disclosed herein enables bale wrap assemblies to be utilized in the order the bale wrap assemblies are disposed within the carriage. As a result, the bale wrap assemblies may be utilized quickly (e.g., as compared to a configuration in which the first bale wrap assembly utilized is the most recent bale wrap assembly disposed within a storage compartment), thereby reducing the duration that a bale wrap assembly may be exposed to the environment.

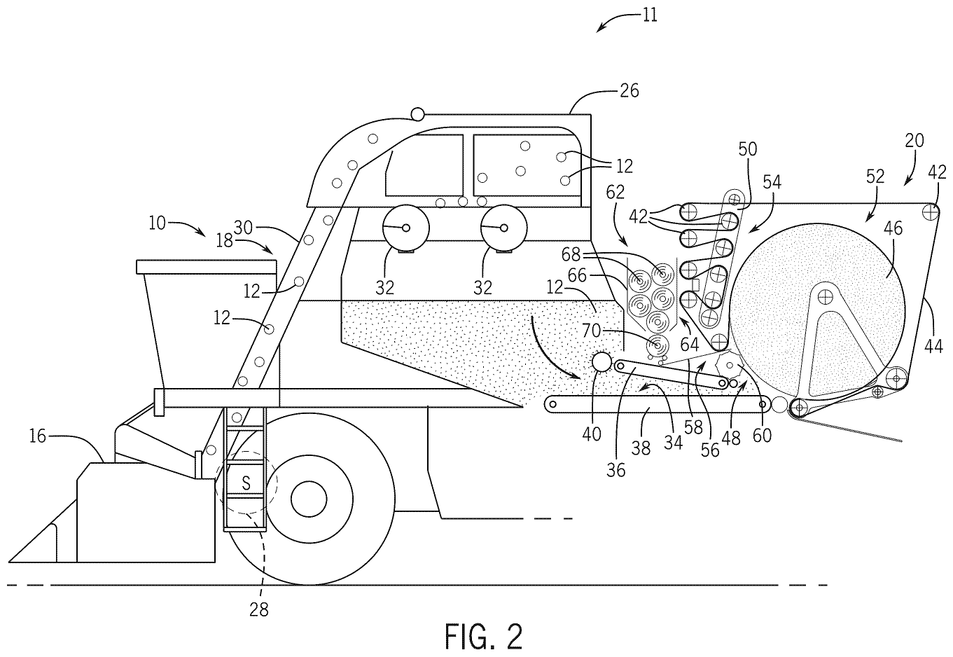

FIG. 2 is a schematic view of an embodiment of an agricultural product transport assembly 11 and an embodiment of a baler 20 that may be employed within the agricultural machine system 10 of FIG. 1. As previously discussed, the header 16 of the agricultural machine system 10 includes drums configured to harvest the agricultural product 12 (e.g., cotton) from the field. Furthermore, the air-assisted conveying system 18 is configured to move the agricultural product 12 from the drums of the header 16 to the accumulator assembly 26. In the illustrated embodiment, the air-assisted conveying system 18 includes a conveying air source 28 configured to output a conveying air flow through one or more ducts 30. Each duct 30 receives the agricultural product 12 (e.g., cotton) from the header 16, and the conveying airflow output by the conveying air source 28 drives the agricultural product to move through the duct(s) 30 from the header 16 to the accumulator assembly 26. In the illustrated embodiment, the agricultural product transport assembly 11 includes augers 32 configured to distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport system 11 includes a first belt (e.g., belt) 36 configured to move the agricultural product 12 from the accumulator assembly 26 to the baler 20. The first belt 36 is configured to rotate in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 is configured to cooperate with the first belt 36 to move the agricultural product 12 from the accumulator assembly 26 to the baler 20. Furthermore, in the illustrated embodiment, the conveying system 34 includes an agitation roller 40 positioned upstream of the first belt 36. The agitation roller 40 is configured to agitate the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 configured to establish tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more feed rollers. The feed rollers drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated.

In certain embodiments, during the harvesting process, the conveying system 34 and the baler 20 may be periodically activated to transfer the agricultural product 12 from the accumulator assembly 26 to the baler 20 and to form the bale 46. For example, as the agricultural machine system 10 traverses a field, the agricultural product 12 may accumulate within the accumulator assembly 26. After a selected duration, the conveying system 34 may be activated to transfer the agricultural product 12 from the accumulator assembly 26 to the baler 20. For example, the conveying system 34 may move the agricultural product 12 toward the baler 20 at a significantly faster rate than the air-assisted conveying system 18 moves the agricultural product 12 into the accumulator assembly 26. Concurrently with activation of the conveying system 34, the baler 20 may be activated to initiate the bale forming process, as described above. After another selected duration, the conveying system 34 and the baler 20 may be deactivated to enable the accumulator assembly 26 to collect additional agricultural product 12. In certain embodiments, the conveying assembly 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural machine system 10 may utilize less energy during the harvesting process (e.g., as compared to continuously operating the conveying system and the baler).

In the illustrated embodiment, the agricultural machine system 10 includes a bale wrap management system 62 having a bale wrap assembly storage compartment 64 and a bale wrap feeding assembly. As discussed in detail below, the bale wrap assembly storage compartment 64 has a storage compartment frame 66 and a carriage movably coupled to the storage compartment frame. The carriage is configured to store multiple bale wrap assemblies 68, and the carriage is configured to move with respect to a vertical axis of the agricultural machine system 10 between a storage position and a delivery position. Each bale wrap assembly 68 includes a shaft and a bale wrap 58 disposed about the shaft to form a roll.

Furthermore, as discussed in detail below, the bale wrap feeding assembly includes a feeding assembly frame and a bale wrap assembly support coupled to the feeding assembly frame. The feeding assembly frame is configured to move with respect to a lateral axis of the agricultural machine system 10 from a feeding position to a loading position. In addition, the bale wrap assembly support is configured to support an active bale wrap assembly 70. The bale wrap assembly support is configured to receive the active bale wrap assembly 70 from the carriage while the carriage is in the delivery position and the feeding assembly frame is in the feeding position. Furthermore, the feeding assembly frame is configured to extract the active bale wrap assembly from the carriage via movement of the feeding assembly frame from the feeding position to the loading position while the carriage is in the delivery position.

To transfer a bale wrap assembly from the carriage of the bale wrap assembly storage compartment to the bale wrap feeding assembly, the carriage is moved with respect to the vertical axis from the storage position to the delivery position. With the feeding assembly frame in the feeding position and the carriage in the delivery position, the bale wrap assembly is received onto the bale wrap assembly support of the bale wrap feeding assembly. As a result, the bale wrap assembly becomes the active bale wrap assembly. The feeding assembly frame is then moved with respect to the lateral axis from the feeding position to the loading position to extract the active bale wrap assembly from the carriage. The bale wrap assembly management system disclosed herein enables a large number of bale wrap assemblies (e.g., 3, 4, 5, 6, 7, 8, or more) to be stored in a small area of the agricultural machine system, thereby reducing the size of the agricultural machine system (e.g., as compared to an agricultural machine system that stores bale wrap assemblies on individual mounts). Furthermore, the bale wrap assembly management system disclosed herein enables bale wrap assemblies to be utilized in the order the bale wrap assemblies are disposed within the carriage. As a result, bale wrap assemblies may be utilized quickly (e.g., as compared to a configuration in which the first bale wrap assembly utilized is the most recent bale wrap assembly disposed within a storage compartment), thereby reducing the duration that a bale wrap assembly may be exposed to the environment.

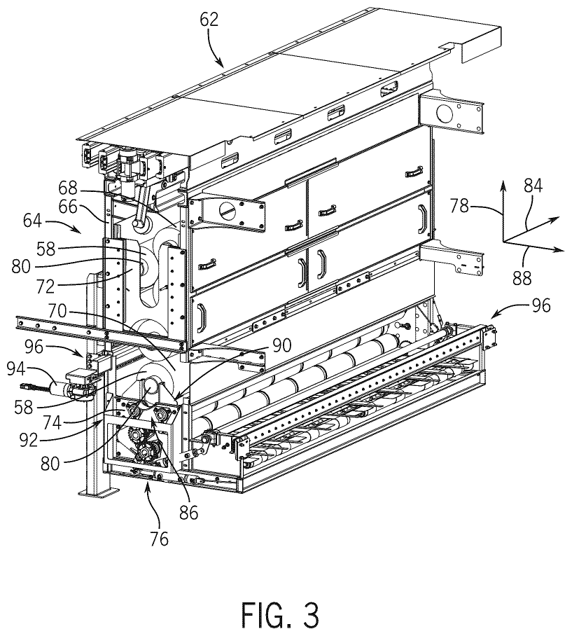

FIG. 3 is a perspective view of an embodiment of a bale wrap assembly management system 62 that may be employed within the agricultural machine system of FIG. 1, in which the carriage 72 of the bale wrap storage compartment 64 of the bale wrap assembly management system 62 is in a storage position, and the feeding assembly frame 74 of the bale wrap feeding assembly 76 of the bale wrap assembly management system 62 is in a feeding position. As previously discussed, the carriage 72 of the bale wrap storage compartment 64 is configured to store multiple bale wrap assemblies 68, and the carriage 72 is configured to move with respect to the vertical axis 78 of the agricultural machine system between the illustrated storage position and a delivery position. As illustrated, each bale wrap assembly 68 includes a shaft 80 and a bale wrap 58 disposed about the shaft 80 to form a roll. In addition, in the illustrated embodiment, each bale wrap assembly 68 (e.g., a rotational axis of each bale wrap assembly 68) extends along the lateral axis 84 of the agricultural machine system.

Furthermore, as previously discussed, the bale wrap assembly support 86 of the bale wrap feeding assembly 76 is coupled to the feeding assembly frame 74, and the feeding assembly frame 74 is configured to move with respect to the lateral axis 84 from the illustrated feeding position to the loading position. In addition, the bale wrap assembly support 86 is configured to support the active bale wrap assembly 70. The bale wrap assembly support 86 is configured to receive the active bale wrap assembly 70 from the carriage 72 while the carriage 72 is in the delivery position and the feeding assembly frame 74 is in the illustrated feeding position. Furthermore, the feeding assembly frame 74 is configured to extract the active bale wrap assembly 70 from the carriage 72 via movement of the feeding assembly frame 74 from the illustrated feeding position to the loading position while the carriage is in the delivery position. In addition, while the feeding assembly frame 74 is in the illustrated feeding position, the bale wrap feeding assembly 76 is configured to feed the bale wrap 58 of the active bale wrap assembly 70 toward the bale with respect to a longitudinal axis 88 of the agricultural machine system.

In the illustrated embodiment, the bale wrap assembly support 86 includes a first support roller 90 rotatably and non-movably coupled to the feeding assembly frame 74, and the bale wrap assembly support 86 includes a second support roller 92 rotatably and non-movably coupled to the feeding assembly frame 74. While the bale wrap assembly support includes two support rollers in the illustrated embodiment, in other embodiments, the bale wrap assembly support may include more or fewer support rollers (e.g., 0, 1, 3, 4, or more). For example, in certain embodiments, the support rollers may be omitted, and the bale wrap assembly support may include other suitable device(s) to support the active bale wrap assembly (e.g., cradle, support rod(s), support bushing(s), etc.).

As previously discussed, the feeding assembly frame 74 is configured to move with respect to the lateral axis 84 between the illustrated feeding position and the loading position. As discussed in detail below, with the feeding assembly frame 74 in the loading position, the bale wrap 58 of the active bale wrap assembly 70 may be loaded through feed rollers of the bale wrap feeding assembly 76. In the illustrated embodiment, the bale wrap feeding assembly 76 includes a motor 94 (e.g., feeding assembly frame drive motor) configured to drive the feeding assembly frame 74 to move between the illustrated feeding position and the loading position. The motor 94 may include an electric motor, a pneumatic motor, a hydraulic motor, another suitable type of motor, or a combination thereof. In certain embodiments, a track is coupled to the feeding assembly frame, a gear is coupled to a shaft of the motor, and the gear is engaged with the track. The motor is configured to drive the gear to rotate, thereby driving the feeding assembly frame to move with respect to the lateral axis. However, in other embodiments, another suitable mechanism (e.g., screw drive, etc.) may enable the motor to drive the feeding assembly frame to move with respect to the lateral axis. Furthermore, in certain embodiments, the bale wrap feeding assembly may include another suitable actuator (e.g., electric linear actuator, hydraulic cylinder, pneumatic cylinder, etc.) configured to drive the feeding assembly frame to move with respect to the lateral axis. In addition, in certain embodiments, the bale wrap feeding assembly may not include any device (e.g., motor, actuator, etc.) configured to drive the feeding assembly frame to move between the feeding and loading positions. In such embodiments, an operator may manually move the feeding assembly frame with respect to the lateral axis between the feeding and loading positions.

In the illustrated embodiment, the bale wrap feeding assembly 76 includes track assemblies 96 configured to guide the feeding assembly frame 74 to move with respect to the lateral axis 84 between the illustrated feeding position and the loading position. In the illustrated embodiment, the bale wrap feeding assembly 76 includes two track assemblies 96 positioned on opposite longitudinal ends of the feeding assembly frame 74. However, in other embodiments, the bale wrap feeding assembly may include more or fewer track assemblies (e.g., 1, 3, 4, or more), and each track assembly may be positioned at any suitable location on the frame. In addition, while the bale wrap feeding assembly 76 includes track assemblies 96 in the illustrated embodiment, in other embodiments, the bale wrap feeding assembly may include any other suitable assemblies (e.g., alone or in combination with the track assembly/assemblies) to guide movement of the feeding assembly frame with respect to the lateral axis, such as one or more slot and groove assemblies, one or more protrusion and recess assemblies, etc.

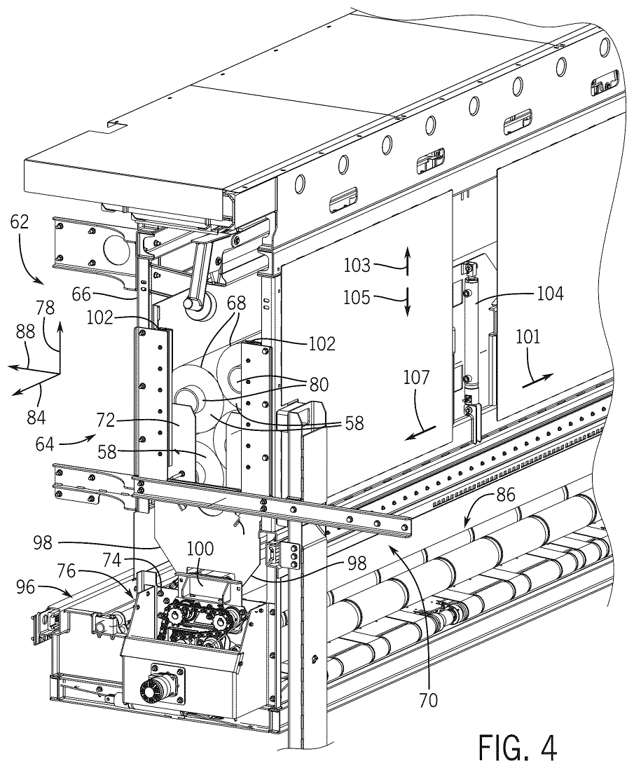

FIG. 4 is a perspective view of a portion of the bale wrap assembly management system 62 of FIG. 3, in which the carriage 72 is in the delivery position, and the feeding assembly frame 74 is in the feeding position. As previously discussed, the bale wrap assembly support 86 of the bale wrap feeding assembly 76 is configured to receive the active bale wrap assembly 70 from the carriage 72 while the carriage 72 is in the illustrated delivery position and the feeding assembly frame 74 is in the illustrated feeding position. In addition, the feeding assembly frame 74 is configured to extract the active bale wrap assembly 70 from the carriage 72 via movement of the feeding assembly frame 74 from the feeding position to the loading position while the carriage 72 is in the delivery position.

In the illustrated embodiment, the carriage 72 includes a pair of feed lips 98 configured to support the active bale wrap assembly 70 while the carriage 72 is in the delivery position and the active bale wrap assembly 70 is disposed on the bale wrap assembly support 86. The feed lips 98 are also configured to enable the feeding assembly frame 74 to extract the active bale wrap assembly 70 from the carriage 72 while the carriage is in the delivery position. Furthermore, the feeding assembly frame 74 includes a protrusion 100 configured to engage a lateral end of the active bale wrap assembly 70 while the carriage 72 is in the delivery position. Accordingly, as the feeding assembly frame 74 moves in a first lateral direction 101 from the feeding position to the loading position, contact between the protrusion 100 and the lateral end of the active bale wrap assembly 70 drives the active bale wrap assembly 70 to move with the feeding assembly frame 74, thereby extracting the active bale wrap assembly from the feed lips 98 of the carriage 72. While the carriage 72 includes feed lips 98 in the illustrated embodiment, in other embodiments, the carriage may include any other suitable structure(s) configured to support the active bale wrap assembly and to enable the feeding assembly frame to extract the active bale wrap assembly from the carriage (e.g., support rod(s), support plate(s), etc.).

In the illustrated embodiment, the bale wrap assembly storage compartment 64 includes track assemblies 102 coupled to the storage compartment frame 66 and to the carriage 72. The track assemblies 102 are configured to guide the carriage 72 to move with respect to the vertical axis 78 between the delivery position and the storage position. In the illustrated embodiment, the bale wrap assembly storage compartment 64 includes four track assemblies 102, in which two track assemblies are positioned at a first lateral end of the bale wrap assembly storage compartment, and two track assemblies are positioned at a second lateral end of the bale wrap assembly storage compartment. However, in other embodiments, the bale wrap assembly storage compartment may include more or fewer track assemblies (e.g., 1, 2, 3, 5, 6, or more), and each track assembly may be positioned at any suitable location on the storage compartment frame. In addition, while the bale wrap assembly storage compartment 64 includes track assemblies 102 in the illustrated embodiment, in other embodiments, the bale wrap assembly storage compartment may include any other suitable assembly/assemblies (e.g., alone or in combination with the track assembly/assemblies) to guide movement of the carriage with respect to the vertical axis, such as one or more slot and groove assemblies, one or more protrusion and recess assemblies, etc.

In the illustrated embodiment, the bale wrap assembly storage compartment 64 includes an actuator 104 (e.g., carriage actuator) coupled to the storage compartment frame 66 and to the carriage 72. The actuator 104 is configured to drive the carriage 72 to move in an upward vertical direction 103 from the illustrated delivery position to the storage position. In the illustrated embodiment, the actuator 104 includes a single hydraulic cylinder. However, in other embodiments, the actuator may include multiple hydraulic cylinders. Furthermore, in certain embodiments, the actuator may include one or more hydraulic cylinders, one or more pneumatic cylinders, one or more linear electric actuators, one or more motor(s) (e.g., with track and gear assembly/assemblies, etc.), other suitable type(s) of actuating device(s), or a combination thereof. In the illustrated embodiment, the actuator 104 is configured to be engaged to drive the carriage 72 to move in the upward vertical direction 103 from the delivery position to the storage position, and the actuator 104 is configured to be disengaged to enable the carriage 72 to move in a downward vertical direction 105 from the storage position to the delivery position under the influence of gravity. However, in other embodiments, the actuator may be configured to drive the carriage to move upwardly from the delivery position to the storage position, and the actuator may be configured to drive the carriage to move downwardly from the storage position to the delivery position. Furthermore, in certain embodiments, the actuator may be omitted, and an operator may manually move the carriage between the delivery and storage positions. In such embodiments, the bale wrap assembly storage compartment may include spring(s) and/or shock(s) to offset a portion of the weight of the carriage and the bale wrap assemblies within the carriage.

Furthermore, as discussed in detail below, the bale wrap assembly storage compartment 64 includes a support coupled to the storage compartment frame 66. The support is configured to support a subsequent bale wrap assembly while the carriage is in the illustrated delivery position to enable the feeding assembly frame 74 to extract the active bale wrap assembly 70. For example, to transfer a bale wrap assembly from the carriage 72 to the bale wrap feeding assembly 76, the actuator 104 is deactivated, thereby enabling the carriage 72 to move in the downward vertical direction 105 from the storage position to the delivery position under the influence of gravity. The feed lips 98 support the bale wrap assembly while the carriage is in the storage position, the delivery position, and the positions in between the storage and delivery positions. With the feeding assembly frame 74 in the feeding position and the carriage 72 in the delivery position, the bale wrap assembly is received onto the bale wrap assembly support 86, such that the bale wrap assembly becomes the active bale wrap assembly 70. While the carriage 72 is in the delivery position, the support supports a subsequent bale wrap assembly, thereby enabling the feeding assembly frame 74 to extract the active bale wrap assembly 70. The feeding assembly frame drive motor is activated to drive the feeding assembly frame 74 to move in the first lateral direction 101 from the feeding position to the loading position. As the feeding assembly frame 74 moves toward the loading position, contact between the protrusion 100 and the active bale wrap assembly 70 (e.g., the shaft 80 of the active bale wrap assembly 70) extracts the active bale wrap assembly 70 from the carriage 72. Furthermore, the actuator 104 is activated to drive the carriage 72 to move in the upward vertical direction 103 from the delivery position to the storage position. With the feeding assembly frame 74 in the loading position, the bale wrap 58 of the active bale wrap assembly 70 may be loaded between feed rollers of the bale wrap feeding assembly 76. The feeding assembly frame drive motor is then activated to drive the feeding assembly frame 74 to move in a second lateral direction 107 from the loading position to the feeding position. With the feeding assembly frame 74 in the feeding position, the feed rollers of the bale wrap feeding assembly 76 may drive the bale wrap 58 of the active bale wrap assembly 70 to move toward the bale.

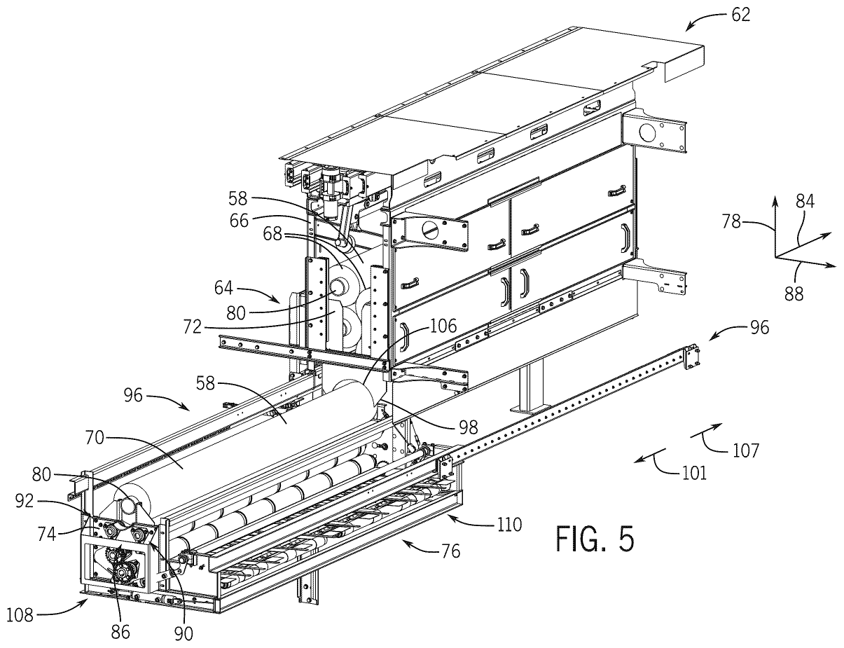

FIG. 5 is a perspective view of the bale wrap assembly management system 62 of FIG. 3, in which the carriage 72 is in the delivery position, and the feeding assembly frame 74 is in the loading position. As previously discussed, the bale wrap support 86 is configured to receive the active bale wrap assembly 70 from the carriage 72 while the carriage 58 is in the illustrated delivery position and the feeding assembly frame 74 is in the feeding position. In addition, the feeding assembly frame 74 is configured to extract the active bale wrap assembly 70 from the carriage 72 via movement of the feeding assembly frame 74 in the first lateral direction 101 from the feeding position to the illustrated loading position while the carriage 72 is in the illustrated delivery position. Furthermore, as previously discussed, the feed lips 98 of the carriage 72 are configured to support the active bale wrap assembly 70 while the carriage is in the illustrated delivery position and the active bale wrap assembly 70 is disposed on the bale wrap assembly support 86. Accordingly, contact between the protrusion of the feeding assembly frame 74 and a lateral end of the active bale wrap assembly 70 drives the active bale wrap assembly 70 to move with the feeding assembly frame 74 from the feeding position to the illustrated loading position, thereby extracting the active bale wrap assembly 70 from the carriage 72 via an opening 106 in the carriage 72. In addition, the support supports the subsequent bale wrap assembly 68 while the carriage 72 is in the delivery position to enable the feeding assembly frame 74 to extract the active bale wrap assembly 70.

With the feeding assembly frame 74 in the illustrated loading position, the bale wrap 58 of the active bale wrap assembly 70 may be loaded into the bale wrap feeding assembly 76. In the illustrated embodiment, the bale wrap feeding assembly 76 includes feed rollers 108 and a belt assembly 110. The bale wrap 58 of the active bale wrap assembly 70 may be routed through the feed rollers 108 and into the belt assembly 110, thereby loading the bale wrap 58 into the bale wrap feeding assembly 76. With the feeding assembly frame 74 in the illustrated loading position, an operator may access the entire lateral extent of the feed rollers 108 and the belt assembly 110, thereby facilitating efficient loading of the bale wrap between the feed rollers. In addition, the ability to move the feeding assembly frame to the illustrated loading position enhances access to multiple components of the bale wrap feeding assembly, thereby facilitating maintenance and repair operations. Furthermore, in certain embodiments, the bale wrap feeding assembly 76 may receive the active bale wrap assembly 70 while the feeding assembly frame 74 is in the illustrated loading position (e.g., in situations in which a type of bale wrap not present in the bale wrap assembly storage compartment is desired, in situations in which the bale wrap assembly storage compartment is empty, etc.).

After the bale wrap 58 of the active bale wrap assembly 70 is loaded into the bale wrap feeding assembly 76, the feeding assembly frame 74 may be moved in the second lateral direction 107 from the illustrated loading position to the feeding position. For example, the feeding assembly frame drive motor may drive the feeding assembly frame to move from the illustrated loading position to the feeding position. The carriage 72 may be moved to the storage position before or after the feeding assembly frame 74 is moved to the feeding position. With the feeding assembly frame 74 in the feeding position, the bale wrap feeding assembly 76 may feed the bale wrap 58 of the active bale wrap assembly 70 toward the bale.

In certain embodiments, the bale wrap management system includes a control panel positioned proximate to the feeding assembly frame and configured to enable an operator located proximate to the feeding assembly frame to access the control panel. The control panel may include controls configured to enable the operator to control each motor and actuator of the bale wrap assembly management system. For example, the control panel may enable the operator to control the carriage actuator to move the carriage from the storage position to the delivery position. Furthermore, the control panel may enable the operator to control the feeding assembly frame drive motor to move the feeding assembly frame from the feeding position to the loading position, thereby extracting the active bale wrap assembly from the carriage. In addition, the control panel may enable the operator to control the carriage actuator to move the carriage from the delivery position to the storage position. The control panel may also enable the operator to control the feeding assembly frame drive motor to move the feeding assembly from the loading position to the feeding position.

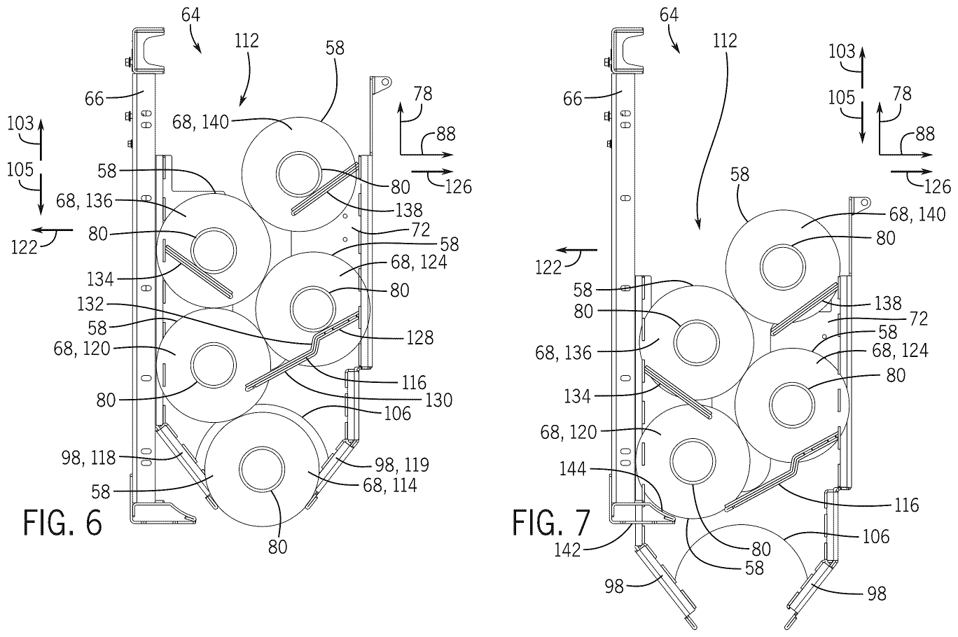

FIG. 6 is a side view of a portion of the bale wrap assembly storage compartment 64 of the bale wrap assembly management system of FIG. 3, in which the carriage 72 is in the storage position and contains five bale wrap assemblies 68. In the illustrated embodiment, the carriage 72 includes an inlet 112 configured to receive each bale wrap assembly 68 via downward movement of the bale wrap assembly 68 with respect to the vertical axis 78 (e.g., in the downward vertical direction 105). As illustrated, the feed lips 98 of the carriage 72 support a first bale wrap assembly 114 (e.g., active bale wrap assembly) while the first bale wrap assembly 114 is in a first bale wrap assembly position. In addition, the bale wrap assembly storage compartment 64 includes first carriage arms 116 coupled to the carriage 72. The first carriage arms 116 are configured to guide the first bale wrap assembly 114 toward a first feed lip 118 as the first bale wrap assembly 114 moves downwardly from the inlet 112, and the first feed lip 118 is configured to guide the first bale wrap assembly 114 to the first bale wrap assembly position. In the illustrated embodiment, the first carriage arms 116 are sloped downwardly and configured to engage the shaft 80 of each bale wrap assembly 68, and the feed lips 98 (e.g., the first feed lip 118 and a second feed lip 119) are configured to engage the bale wrap 58 of each bale wrap assembly. Accordingly, as the first bale wrap assembly 114 moves downwardly with respect to the vertical axis 78 (e.g., in the downward vertical direction 105), the shaft 80 of the first bale wrap assembly 114 engages the first carriage arms 116, such that the first bale wrap assembly 114 is directed toward the first feed lip 118. In addition, engagement between the bale wrap 58 of the first bale wrap assembly 114 and the first feed lip 118 directs the first bale wrap assembly 114 to move to the first bale wrap assembly position, as illustrated.

In the illustrated embodiment, the shaft 80 of each bale wrap assembly 68 extends beyond both lateral ends of the bale wrap 58. The first carriage arms 116 include one carriage arm positioned on a first lateral side of the carriage 72 and another carriage arm positioned on a second lateral side of the carriage 72. Each carriage arm of the first carriage arms is configured to engage the portion of the bale wrap assembly shaft 80 that extends laterally beyond the bale wrap 58 to guide the respective bale wrap assembly 68 toward the first feed lip 118.

Furthermore, the first carriage arms 116 are configured to guide a second bale wrap assembly 120 (e.g., subsequent bale wrap assembly) toward a second bale wrap assembly position as the second bale wrap assembly moves downwardly with respect to the vertical axis 78 from the inlet 112. As illustrated, the second bale wrap assembly position is above the first bale wrap assembly position (e.g., the position of the first bale wrap assembly 114) with respect to the vertical axis 78, and the second bale wrap assembly position is longitudinally offset (e.g., offset with respect to the longitudinal axis 88) from the bale wrap assembly position along a first longitudinal direction 122. As used herein with respect to the bale wrap assembly positions, the bale wrap assembly position corresponds to a location of the rotational axis of the respective bale wrap assembly while the respective bale wrap assembly is located at the bale wrap assembly position. As previously discussed, the first carriage arms 116 are sloped downwardly and configured to engage the shaft 80 of each bale wrap assembly 68. Accordingly, as the second bale wrap assembly 120 moves downwardly with respect to the vertical axis 78 (e.g., in the downward vertical direction 105), the shaft 80 of the second bale wrap assembly 120 engages the first carriage arms 116, such that the second bale wrap assembly 120 is directed toward the second bale wrap assembly position, as illustrated. With the second bale wrap assembly 120 in the second bale wrap assembly position, downward movement of the second bale wrap assembly 120 is blocked by contact with the first bale wrap assembly 114.

In addition, the first carriage arms 116 are configured to support a third bale wrap assembly 124 while the third bale wrap assembly 124 is in a third bale wrap assembly position. As illustrated, the third bale wrap assembly position is above the first and second bale wrap assembly positions (e.g., the positions of the first and second bale wrap assemblies) with respect to the vertical axis 78, and the third bale wrap assembly position is longitudinally offset (e.g., offset with respect to the longitudinal axis 88) from the first and second bale wrap assembly positions along a second longitudinal direction 126. With the third bale wrap assembly 124 in the third bale wrap assembly position, downward movement of the third bale wrap assembly 124 is blocked by contact with the second bale wrap assembly 120. In the illustrated embodiment, each first carriage arm 116 has a first portion 128, a second portion 130, and a bent section 132 between the first and second portions. The first portions 128 of the first carriage arms 116 are configured to support the third bale wrap assembly 124 while the third bale wrap assembly 124 is in the third bale wrap assembly position.

In the illustrated embodiment, the bale wrap assembly storage compartment 64 includes second carriage arms 134 coupled to the carriage 72. The second carriage arms 134 are configured to support a fourth bale wrap assembly 136 while the fourth bale wrap assembly 136 is in a fourth bale wrap assembly position. As illustrated, the fourth bale wrap assembly position is above the first, second, and third bale wrap assembly positions (e.g., the positions of the first, second, and third bale wrap assemblies) with respect to the vertical axis 78, and the fourth bale wrap assembly position is longitudinally aligned (e.g., aligned with respect to the longitudinal axis 88) with the second bale wrap assembly position. With the fourth bale wrap assembly 136 in the fourth bale wrap assembly position, downward movement of the fourth bale wrap assembly 136 is blocked by contact with the third bale wrap assembly 124. The second carriage arms 134 include one carriage arm positioned on a first lateral side of the carriage 72 and another carriage arm positioned on a second lateral side of the carriage 72. Each carriage arm of the second carriage arms is configured to engage the portion of the bale wrap assembly shaft 80 that extends laterally beyond the bale wrap 58 of the respective bale wrap assembly 68.

In the illustrated embodiment, the bale wrap assembly storage compartment 64 includes third carriage arms 138 coupled to the carriage 72. The third carriage arms 138 are configured to support a fifth bale wrap assembly 140 while the fifth bale wrap assembly 140 is in a fifth bale wrap assembly position. As illustrated, the fifth bale wrap assembly position is above the first, second, third, and fourth bale wrap assembly positions (e.g., the positions of the first, second, third, and fourth bale wrap assemblies) with respect to the vertical axis 78, and the fifth bale wrap assembly position is longitudinally aligned (e.g., aligned with respect to the longitudinal axis 88) with the third bale wrap assembly position. With the fifth bale wrap assembly 140 in the fifth bale wrap assembly position, downward movement of the fifth bale wrap assembly 140 is blocked by contact with the fourth bale wrap assembly 136. The third carriage arms 138 include one carriage arm positioned on a first lateral side of the carriage 72 and another carriage arm positioned on a second lateral side of the carriage 72. Each carriage arm of the third carriage arms is configured to engage the portion of the bale wrap assembly shaft 80 that extends laterally beyond the bale wrap 58 of the respective bale wrap assembly 68. The first, second, and third carriage arms enable the carriage to store five bale wrap assemblies 68. Because the bale wrap assemblies are utilized (e.g., provided to the bale wrap feeding assembly) in the same order as the bale wrap assemblies are disposed within the carriage, the bale wrap assemblies may be utilized quickly (e.g., as compared to a configuration in which the first bale wrap assembly utilized is the most recent bale wrap assembly disposed within a storage compartment), thereby reducing the duration that a bale wrap assembly may be exposed to the environment.

FIG. 7 is a side view of a portion of the bale wrap assembly storage compartment 64 of FIG. 6, in which the carriage 72 is in the delivery position and contains four bale wrap assemblies 68. As previously discussed, the carriage 72 is configured to move downwardly with respect to the vertical axis 78 (e.g., in the downward vertical direction 105) from the storage position, as shown in FIG. 6, to the illustrated delivery position. With the carriage 72 in the illustrated delivery position, the feeding assembly may move with respect to the lateral axis from the feeding position to the loading position, thereby extracting the first bale wrap assembly (e.g., the active bale wrap assembly) from the carriage 72.

In the illustrated embodiment, the bale wrap assembly storage compartment 64 includes a support 142 coupled to the storage compartment frame 66. The support 142 is configured to engage the bale wrap 58 of the second bale wrap assembly (e.g., subsequent bale wrap assembly) 120 to support the second bale wrap assembly (e.g., subsequent bale wrap assembly) 120 while the carriage 72 is in the illustrated delivery position, thereby enabling the feeding assembly frame to extract the first bale wrap assembly (e.g., the active bale wrap assembly). For example, the combination of the support provided by the support 142 and the friction between the bale wrap 58 of the second bale wrap assembly 120 and the bale wrap 58 of the third bale wrap assembly 124 blocks the second bale wrap assembly 120 from moving downwardly toward the feed lips 98, thereby establishing a gap between the second bale wrap assembly 120 and the first bale wrap assembly (e.g., active bale wrap assembly) engaged with the feed lips 98. The gap enables the feeding assembly frame to drive the first bale wrap assembly (e.g., active bale wrap assembly) laterally through the opening 106, thereby extracting the first bale wrap assembly (e.g., active bale wrap assembly) from the carriage 72.

In the illustrated embodiment, the support 142 includes a curved engagement surface 144 configured to match the exterior curved surface of each bale wrap assembly 68. However, in other embodiments, the support may have an engagement surface with another suitable shape. Furthermore, the bale wrap storage compartment may have any suitable number of supports, and each support may extend along any suitable lateral extent of the storage compartment frame. For example, in certain embodiments, the bale wrap storage compartment may include 1, 2, 3, 4, 5, 6, or more supports (e.g., distributed along the lateral extent of the storage compartment frame). In addition, the carriage 72 includes an opening for each support 142, thereby enabling each support to extend into the interior of the carriage and enabling the carriage to move between the delivery and transport positions without contacting the support(s).

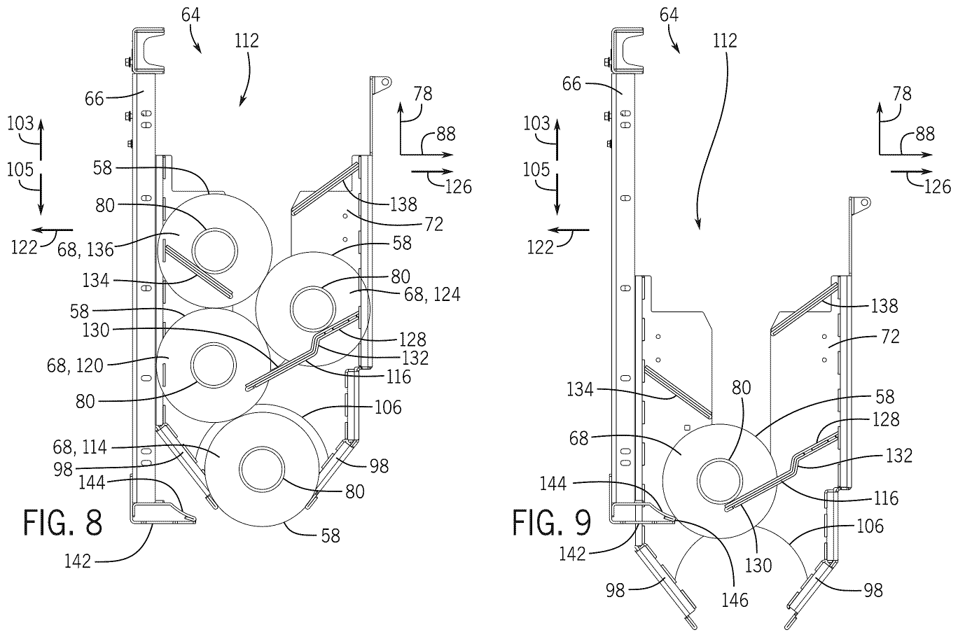

FIG. 8 is a side view of a portion of the bale wrap assembly storage compartment 64 of FIG. 6, in which the carriage 72 is in the storage position and contains four bale wrap assemblies 68. For example, one bale wrap assembly may have been extracted from the carriage while the carriage was in the delivery position. As the carriage 72 moves in the upward vertical direction 103 toward the storage position, the support 142 disengages the second bale wrap assembly (e.g., subsequent bale wrap assembly), thereby enabling the second bale wrap assembly to move downwardly to the first bale wrap assembly position. As a result, the second bale wrap assembly becomes the first bale wrap assembly (e.g., active bale wrap assembly). Furthermore, the carriage arms guide the other bale wrap assemblies to the next lower bale wrap assembly positions. As a result, the first bale wrap assembly 114 is supported by the feed lips 98. In addition, downward movement of the second bale wrap assembly 120 is blocked by contact with the first bale wrap assembly 114. Furthermore, the shaft 80 of the third bale wrap assembly 124 is engaged with the first portions 128 of the first carriage arms 116, and downward movement of the third bale wrap assembly 124 is blocked by contact with the second bale wrap assembly 120. In addition, the shaft 80 of the fourth bale wrap assembly 136 is engaged with the second carriage arms 134, and downward movement of the fourth bale wrap assembly 136 is blocked by contact with the third bale wrap assembly 124.

FIG. 9 is a side view of a portion of the bale wrap assembly storage compartment 64 of FIG. 6, in which the carriage 72 is in the delivery position and contains one bale wrap assembly 68. As previously discussed, the support 142 is configured to engage the bale wrap 58 of a bale wrap assembly 68 to support the bale wrap assembly (e.g., subsequent bale wrap assembly) 68 while the carriage 72 is in the illustrated delivery position, thereby enabling the feeding assembly frame to extract the active bale wrap assembly. Because a single bale wrap assembly 68 is disposed within the carriage 72, no additional bale wrap assembly is present to hold the single bale wrap assembly 68 in the second bale wrap assembly position. Accordingly, the single bale wrap assembly 68 moves downwardly under the influence of gravity until the shaft 80 of the single bale wrap assembly 68 engages the second portions 130 of the first carriage arms 116. Contact between the shaft 80 and the second portions of the first carriage arms 116, and contact between the bale wrap 58 and the support 142 (e.g., a tip 146 of the support 142) supports the single bale wrap assembly 68 within the carriage 72 while the carriage is in the delivery position. The first carriage arms 116 (e.g., the first portions 128, the second portions 130, and the bent sections 132) may be particularly configured to support the third bale wrap assembly while the third bale wrap assembly is in the third bale wrap assembly position, to guide the first bale wrap assembly toward the first feed lip, to guide the second bale wrap assembly toward the second bale wrap assembly position, and to cooperate with the support to support the single bale wrap assembly. As the carriage 72 moves upwardly with respect to the vertical axis 78 from the illustrated delivery position to the storage position, gravity may drive the single bale wrap assembly 68 to move downwardly, such that the single bale wrap assembly 68 engages the feed lips 98, thereby positioning the single bale wrap assembly 68 for subsequent extraction by the feeding assembly frame.

While the carriage 72 is configured to contain five bale wrap assemblies 68 in the illustrated embodiment, in other embodiments, the carriage may be configured to contain more or fewer bale wrap assemblies. Accordingly, in certain embodiments, the bale wrap assembly storage compartment may include more or fewer carriage arms (e.g., based on the capacity of the carriage). Furthermore, while the bale wrap assembly storage compartment (e.g., the carriage and the carriage arms of the bale wrap assembly storage compartment) is configured to arrange the bale wrap assemblies, with the exception of the first bale wrap assembly, in two columns in the illustrated embodiment, in other embodiments, the bale wrap assembly storage compartment (e.g., the carriage of the bale wrap assembly storage compartment) may be configured to arrange the bale wrap assemblies (e.g., larger bale wrap assemblies) in a single column. In such embodiments, the carriage arms may be omitted. Furthermore, in such embodiments, the bale wrap assembly storage compartment may include two supports positioned on opposite longitudinal ends of the storage compartment frame to support the subsequent bale wrap assembly while the carriage is in the delivery position. In addition, while each first carriage arm includes two portions and a bent section in the illustrated embodiment, in other embodiments, each first carriage arm may have another suitable shape and/or configuration (e.g., straight, curved, wavy, etc.). In addition, while the second and third carriage arms are straight in the illustrated embodiment, in other embodiments, the second carriage arms and/or the third carriage arms may have another suitable shape and/or configuration (e.g., bent, curved, wavy, etc.).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A bale wrap assembly management system for an agricultural harvester, comprising:
a bale wrap assembly storage compartment, comprising:
a storage compartment frame; and
a carriage movably coupled to the storage compartment frame, wherein the carriage is configured to store a plurality of bale wrap assemblies, and the carriage is configured to move with respect to a vertical axis of the agricultural harvester between a storage position and a delivery position; and
a bale wrap feeding assembly, comprising:
a feeding assembly frame configured to move with respect to a lateral axis of the agricultural harvester from a feeding position to a loading position; and
a bale wrap assembly support coupled to the feeding assembly frame and configured to support an active bale wrap assembly of the plurality of bale wrap assemblies;
wherein the bale wrap assembly support is configured to receive the active bale wrap assembly from the carriage while the carriage is in the delivery position and the feeding assembly frame is in the feeding position, and the feeding assembly frame is configured to extract the active bale wrap assembly from the carriage via movement of the feeding assembly frame from the feeding position to the loading position while the carriage is in the delivery position.

2. The bale wrap assembly management system of claim 1, wherein the bale wrap assembly support comprises:
a first support roller rotatably and non-movably coupled to the feeding assembly frame; and
a second support roller rotatably and non-movably coupled to the feeding assembly frame.

3. The bale wrap assembly management system of claim 1, wherein the bale wrap assembly storage compartment comprises an actuator coupled to the storage compartment frame and to the carriage, and the actuator is configured to drive the carriage to move from the delivery position to the storage position.

4. The bale wrap assembly management system of claim 1, wherein the bale wrap assembly storage compartment comprises a support coupled to the storage compartment frame, and the support is configured to support a subsequent bale wrap assembly of the plurality of bale wrap assemblies while the carriage is in the delivery position to enable the feeding assembly frame to extract the active bale wrap assembly.

5. The bale wrap assembly management system of claim 1, wherein the bale wrap assembly storage compartment comprises a track assembly coupled to the storage compartment frame and to the carriage, and the track assembly is configured to guide the carriage to move between the delivery position and the storage position.

6. The bale wrap assembly management system of claim 1, wherein the carriage comprises a pair of feed lips configured to support the active bale wrap assembly and to enable the feeding assembly frame to extract the active bale wrap assembly from the carriage.

7. A bale wrap assembly management system for an agricultural harvester, comprising:
a bale wrap assembly storage compartment, comprising:
a storage compartment frame;
a carriage movably coupled to the storage compartment frame, wherein the carriage is configured to store a plurality of bale wrap assemblies, the carriage comprises an inlet configured to receive each bale wrap assembly of the plurality of bale wrap assemblies, the carriage comprises a pair of feed lips configured to support a first bale wrap assembly of the plurality of bale wrap assemblies while the first bale wrap assembly is in a first bale wrap assembly position, and the carriage is configured to move with respect to a vertical axis of the agricultural harvester between a storage position and a delivery position; and
a first carriage arm configured to guide the first bale wrap assembly toward a first feed lip of the pair of feed lips as the first bale wrap assembly moves downwardly from the inlet, and the first feed lip is configured to guide the first bale wrap assembly to the first bale wrap assembly position; and
a bale wrap feeding assembly, comprising:
a feeding assembly frame configured to move with respect to a lateral axis of the agricultural harvester from a feeding position to a loading position; and
a bale wrap assembly support coupled to the feeding assembly frame and configured to support an active bale wrap assembly of the plurality of bale wrap assemblies;
wherein the bale wrap assembly support is configured to receive the first bale wrap assembly from the carriage while the carriage is in the delivery position and the feeding assembly frame is in the feeding position, such that the first bale wrap assembly becomes the active bale wrap assembly, and the feeding assembly frame is configured to extract the active bale wrap assembly from the carriage via movement of the feeding assembly frame from the feeding position to the loading position while the carriage is in the delivery position.

8. The bale wrap assembly management system of claim 7, wherein the first carriage arm is configured to guide a second bale wrap assembly of the plurality of bale wrap assemblies toward a second bale wrap assembly position as the second bale wrap assembly moves downwardly from the inlet, the second bale wrap assembly position is above the first bale wrap assembly position, and the second bale wrap assembly position is longitudinally offset from the first bale wrap assembly position along a first longitudinal direction.

9. The bale wrap assembly management system of claim 8, wherein the first carriage arm is configured to support a third bale wrap assembly of the plurality of bale wrap assemblies while the third bale wrap assembly is in a third bale wrap assembly position, the third bale wrap assembly position is above the first and second bale wrap assembly positions, and the third bale wrap assembly position is longitudinally offset from the first and second bale wrap assembly positions along a second longitudinal direction.

10. The bale wrap assembly management system of claim 9, wherein the bale wrap assembly storage compartment comprises a second carriage arm configured to support a fourth bale wrap assembly of the plurality of bale wrap assemblies while the fourth bale wrap assembly is in a fourth bale wrap assembly position, the fourth bale wrap assembly position is above the first, second, and third bale wrap assembly positions, and the fourth bale wrap assembly position is longitudinally aligned with the second bale wrap assembly position.

11. The bale wrap assembly management system of claim 10, wherein the bale wrap assembly storage compartment comprises a third carriage arm configured to support a fifth bale wrap assembly of the plurality of bale wrap assemblies while the fifth bale wrap assembly is in a fifth bale wrap assembly position, the fifth bale wrap assembly position is above the first, second, third, and fourth bale wrap assembly positions, and the fifth bale wrap assembly position is longitudinally aligned with the third bale wrap assembly position.

12. The bale wrap assembly management system of claim 7, wherein the bale wrap assembly storage compartment comprises a support coupled to the storage compartment frame, and the support is configured to support the second bale wrap assembly while the carriage is in the delivery position to enable the feeding assembly frame to extract the active bale wrap assembly.

13. The bale wrap assembly management system of claim 7, wherein the bale wrap assembly storage compartment comprises an actuator coupled to the storage compartment frame and to the carriage, and the actuator is configured to drive the carriage to move from the delivery position to the storage position.

14. The bale wrap assembly management system of claim 7, wherein the bale wrap assembly storage compartment comprises a track assembly coupled to the storage compartment frame and to the carriage, and the track assembly is configured to guide the carriage to move between the delivery position and the storage position.

15. A method for bale wrap assembly management, comprising:
moving a carriage of a bale wrap assembly storage compartment with respect to a vertical axis of an agricultural harvester from a storage position to a delivery position, wherein the carriage is movably coupled to a storage compartment frame of the bale wrap assembly storage compartment, and the carriage is configured to store a plurality of bale wrap assemblies;
receiving, onto a bale wrap assembly support of a bale wrap feeding assembly, an active bale wrap assembly of the plurality of bale wrap assemblies from the carriage while the carriage is in the delivery position and a feeding assembly frame of the bale wrap feeding assembly is in a feeding position, wherein the bale wrap assembly support is coupled to the feeding assembly frame; and
moving the feeding assembly frame with respect to a lateral axis of the agricultural harvester from the feeding position to a loading position to extract the active bale wrap assembly from the carriage.

16. The method of claim 15, comprising loading a bale wrap of the active bale wrap assembly into the bale wrap feeding assembly while the feeding assembly frame is in the loading position.

17. The method of claim 15, comprising activating an actuator to drive the carriage to move from the delivery position to the storage position.

18. The method of claim 15, wherein moving the feeding assembly frame from the feeding position to the loading position comprises activating an actuator to drive the feeding assembly frame to move from the feeding position to the loading position.

19. The method of claim 15, comprising disposing the plurality of bale wrap assemblies into the carriage via an inlet of the carriage.

20. The method of claim 15, wherein the bale wrap assembly storage compartment comprises a support coupled to the storage compartment frame, and the support is configured to support a subsequent bale wrap assembly of the plurality of bale wrap assemblies while the carriage is in the delivery position to enable the feeding assembly frame to extract the active bale wrap assembly.
